(19) United States
(12) Patent Application Publication
(10) Pub. No.: US 2009/0143089 A1
(43) Pub. Date: Jun. 4, 2009

(54) Apparatus and method for performing an expedited handover using a dedicated ranging channel in a wireless network

(75) Inventors: Baowei Ji, Plano, TX (US); Changhoi Koo, Plano, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/220,890

(22) Filed: Jul. 29, 2008

Related U.S. Application Data
(60) Provisional application No. 60/996,679, filed on Nov. 29, 2007.

(51) Int. Cl. H04B 7/00

(52) U.S. Cl. 455/517

(57) ABSTRACT

A wireless network comprising a plurality of base stations capable of communicating with a plurality of mobile stations, wherein a serving base station is operable to serve a mobile station and a target base station is operable to transmit to the mobile station a message identifying a ranging slot dedicated to the mobile station. The target base station receives a ranging code from the mobile base station before the target base station receives a ranging request message from the mobile station. In an embodiment, the ranging slot may be an exclusive ranging slot dedicated to two or more mobile stations.

### CROSS-REFERENCE TO RELATED APPLICATION(S) AND CLAIM OF PRIORITY

The present application is related to U.S. Provisional Patent No. 60/996,679, filed Nov. 29, 2007, entitled “METHOD FOR EXPEDITED HANDOVER FOR IEEE802.16M”. Provisional Patent No. 60/996,679 is assigned to the assignee of the present application and is hereby incorporated by reference into the present application as if fully set forth herein. The present application hereby claims priority under 35 U.S.C. §119(e) to U.S. Provisional Patent No. 60/996,679.

### TECHNICAL FIELD OF THE INVENTION

The present application relates generally to wireless communications and, more specifically, to a technique for expedited handover using a dedicated ranging channel.

### BACKGROUND OF THE INVENTION

FIG. 1 is a flow diagram illustrating a conventional hard handover procedure according to IEEE 802.16e. As shown in FIG. 1, a convention hard handover begins when a mobile station 102 transmits a mobile station handover request (MOB_MSHO_REQ) message to a serving base station 104 (step 101). Upon receiving the MOB_MSHO_REQ message, serving base station 104 transmits a handover request (HO-Request) to a target base station 106 (step 103). Next, context transfer (step 105) and bearer path registration (step 107) occurs between serving base station 104 and target base station 106. Then, a handover response (HO-Response) message is transmitted from target base station 106 to serving base station 104 (step 109). Upon receiving the HO-Response message, serving base station 104 transmits a mobile base station handover response (MOB_BSHO_RSP) message to mobile station 102 (step 111) and a handover acknowledgment (HO-Ack) message to target base station 106 (step 113). Upon receiving the MOB_BSHO_RSP message, mobile station 102 transmits a mobile handover indication (MOB_HO_IND) message to serving base station 104 (step 115). The time required to complete steps 101 to 115 represent the handover preparation time.

Upon receiving the MOB_HO_IND message from mobile station 102, serving base station 104 transmits a handover confirmation (HO-Confirm) message to target base station 106 (step 117). Target base station 106 responds by transmitting a handover acknowledgment (HO-Ack) message to serving base station 104 (step 119). Mobile station 102 then transmits a ranging code to target base station 106 (step 121) using a shared ranging channel while taking into account certain backoff requirements. Upon receiving the ranging code, and if the ranging is successful, the target base station 106 transmits a ranging response (RNG-RSP) message containing an uplink map (UL-MAP) message with resource allocation information to mobile station 102 (step 123). Upon receiving the RNG-RSP message, mobile station 102 responds by transmitting a ranging request (RNG-REQ) message to target base station 106 (step 125). Target base station 106 then transmits a RNG-RSP message containing assigned connection IDs to mobile station 102 (step 127). Data transfer then occurs between mobile station 102 and target base station 106 (step 129). Finally, bearer path de-registration occurs between serving base station 104 and target base station 106 (step 131). The time required to completed steps 115 to 129 represent the handover interruption time. One of ordinary skill in the art would understand that the first step (i.e., step 101) could also be initiated by the serving base station 104. In other words, the serving base station 104 could initiate a handover by sending an unsolicited MOB_MSHO_RSP message.

Ranging is the process of acquiring the correct timing offset and determining the required power and frequency adjustment in order to align the transmissions from all mobile stations associated with a base station so that those mobile stations appear to be collocated with the base station for orthogonal frequency-division multiplexing (OFDM) or orthogonal frequency-division multiple access physical (OFDMA PHY) layer. Ranging also allows the signaling system transmissions to be received within the appropriate reception thresholds. Any variation in the physical layer delays due to multipath is accounted for in the guard time of the uplink physical layer overhead.

For OFDMA, a mobile station sends a code division multiple access (CDMA) code at a proper initial power level. If the mobile station does not receive a response, the mobile station sends a new CDMA code at a power level one level higher than the initial power level at the next appropriate initial ranging transmission opportunity. If the mobile station receives a RNG-RSP message containing the parameters of the code previously transmitted with a continue status, the mobile station considers the transmission an unsuccessful attempt. The mobile station then implements the corrections specified in the RNG-RSP message and issues another CDMA code after waiting the appropriate backoff delay. If the mobile station receives an UL-MAP message containing a CDMA allocation information element (CDMA_Allocation_IE) with the parameters of the CDMA code previously transmitted (step 123), the mobile station considers the RNG-RSP message as having been successfully received and proceeds to send a unicast RNG-REQ message on the allocated bandwidth (step 125).

When used with the OFDMA PHY layer, the medium access control (MAC) layer defines a single ranging channel. The ranging channel comprises one or more groups of six adjacent subchannels. The groups are defined starting from the first subchannel. Optionally, the ranging channel can comprise eight subchannels. The indices of the subchannels that comprise the ranging channel are specified in the UL-MAP message.

The initial ranging transmission is used by any mobile station wanting to synchronize to the system channel for the first time. The initial ranging transmission is performed over a period of two consecutive symbols. The same ranging code is transmitted on the ranging channel during each symbol with no phase discontinuity between the two symbols. The base station can allocate two consecutive initial ranging slots onto which the mobile station transmits the two consecutive initial ranging codes.

However, the target base station may not be able to decode the RNG-REQ message sent by the mobile station if the mobile station has never performed an initial ranging with the target base station. In particular, the mobile station's timing has not been adjusted by the target base station. In a time division duplex (TDD) system, a mobile station can autonomously adjust the transmitting power based on downlink synchronization. However, the mobile station may not be able to adjust its timing without a command from the target base station. Accordingly, the target base station may not be able to decode the RNG-REQ message, and the mobile station may step over the next OFDM symbol because of the lack of ranging results.

A mobile station should not send a RNG-REQ message unless it has received valid ranging parameters. Typically, a mobile station sends a RNG-REQ message after its initial ranging has resulted in a “Status=Success” indicator in the RNG-RSP message from the target base station.

FIG. 2 is a flow diagram illustrating an optimized handover procedure according to Section 6.3.22.2.1-10 of IEEE 802.16-2005. As shown in FIG. 2, optimized handover also employs steps 101 to 119 as shown in FIG. 1 with regard to the conventional hard handover. However, optimized handover skips the initialization and network access steps of 121 and 123 used in the conventional hard handover and completes all the initialization and access procedures in one step using a RNG_RSP message.

In theory, optimized handover completes the hard handover process more quickly than the conventional hard handover. Optimized handover accomplishes this by having the target base station allocate a dedicated UL resource using a fast ranging information element (Fast_Ranging_IE( )) message (step 201). The mobile station then sends a RNG_REQ message (step 203) using the resources indicated in the Fast_Ranging_IE( ) message. Accordingly, the essential difference between the conventional hard handover and optimized handover is that the target base station allocates a contention-free uplink (UL) resource using the Fast_Ranging_IE( ) message, which allows the target base station to complete the network entry process in one step by sending a RNG_RSP message (step 205).

In the case of fast network re-entry performed using optimized handover, a mobile station could send a RNG-REQ message using the resources indicated by the Fast_Ranging_IE( ) if the mobile station maintains valid ranging parameters.

However, a mobile station should always transmit a ranging code using a ranging slot at the first attempt at transmitting to a base station. It is improper for a mobile station to transmit a RNG-REQ message in its first attempt at communicating with the target base station as done in optimized handover, especially when the mobile station has not adjusted its transmission timing. Furthermore, in reality, optimized handover has a high probability for failing in the first attempt and has to fall back to the conventional handover. Accordingly, optimized handover actually results in even longer handover interruption time than the conventional hard handover procedure.

Therefore, there is a need in the art for an improved handover technique. In particular, there is a need for a handover technique that is capable of reducing handover interruption time.

### SUMMARY OF THE INVENTION

A wireless network comprising a plurality of base stations capable of communicating with a plurality of mobile stations, wherein a serving base station is operable to serve a mobile station and a target base station is operable to transmit to the mobile station a message identifying a ranging slot dedicated to the mobile station. The target base station receives a ranging code from the mobile base station before the target base station receives a ranging request message from the mobile station. In an embodiment, the ranging slot may be an exclusive ranging slot dedicated to two or more mobile stations.

A method for operating a target base station is provided. The method comprises allocating a ranging slot dedicated to a mobile station being served by a serving base station and receiving a ranging code from the mobile station using the ranging slot, wherein the target base station receives the ranging code from the mobile base station before the target base station receives a ranging request message from the mobile station.

In an embodiment of the disclosure, the ranging slot is an exclusive ranging slot dedicated to two or more mobile stations, and the method further comprises assigning a ranging code that is unique to each of the two or more mobile stations and controlling a multiple access interference of the ranging slot using the unique ranging code.

A mobile station capable of communicating with a wireless network having a serving base station and a target base station is provided where the mobile station is operable to receive, from a target base station, a message identifying a ranging slot dedicated to the mobile station, transmit a ranging code to the target base station using the ranging slot, receive a ranging response message transmitted by the target base station, the ranging response message comprising one or more changes required by the target base station, and apply the one or more changes in the ranging response message.

In an embodiment of the disclosure, the ranging slot is dedicated exclusively to two or more mobile stations, and the ranging code is a ranging code unique to the mobile station and is transmitted to the mobile device from the target base station.

To address the above-discussed deficiencies of the prior art, it is a primary object to provide, for use in a wireless communication system, an expedited handover procedure which is completed when a mobile station receives a ranging response message from a target base station and applies all the changes indicated in the ranging response message.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow diagram illustrating a conventional hard handover procedure according to IEEE 802.16e;

FIG. 2 is a flow diagram illustrating an optimized handover procedure according to Section 6.3.22.2.1-10 of IEEE 802.16-2005;

FIG. 3 illustrates an exemplary wireless network that transmits ACK/NACK messages in the uplink according to the principles of the present disclosure;

FIG. 4A is a high-level diagram of an OFDMA transmitter according to one embodiment of the present disclosure;

FIG. 4B is a high-level diagram of an OFDMA receiver according to one embodiment of the present disclosure;

FIG. 5 is a flow diagram illustrating an expedited handover procedure according to an exemplary embodiment of the disclosure;

FIG. 6 is a flowchart illustrating a method for expedited handover according to an exemplary embodiment of the disclosure; and

FIG. 7 is a flowchart illustrating a method for expedited handover according to another exemplary embodiment of the disclosure.

### DETAILED DESCRIPTION OF THE INVENTION

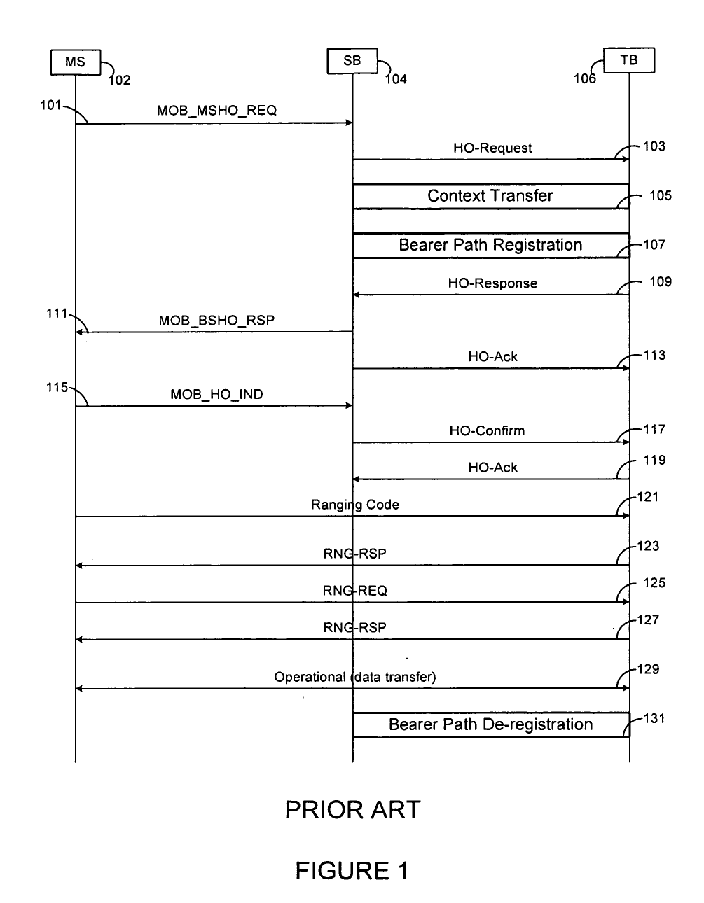

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

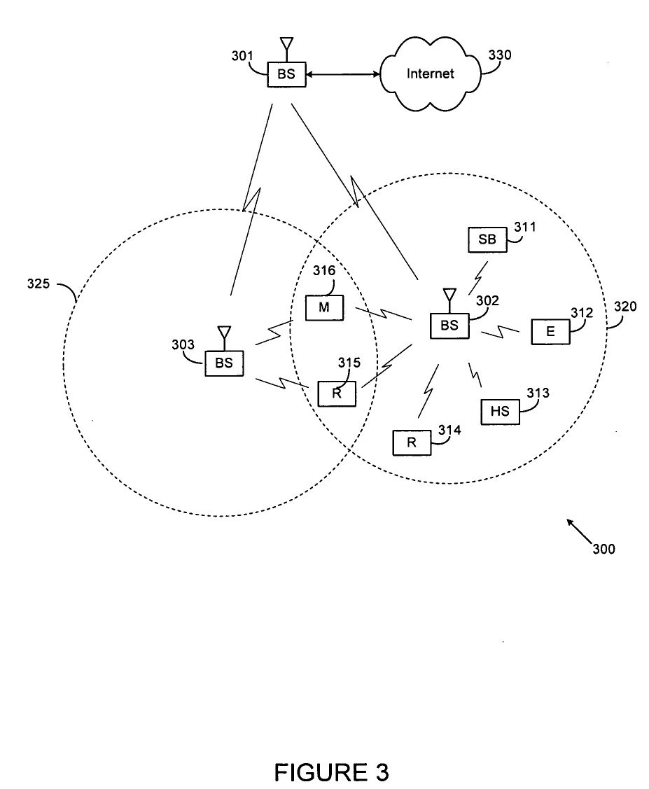

FIG. 3 illustrates exemplary wireless network 300, which transmits ACK/NACK messages according to the principles of the present disclosure. In the illustrated embodiment, wireless network 300 includes base station (BS) 301, base station (BS) 302, base station (BS) 303, and other similar base stations (not shown). Base station 301 is in communication with base station 302 and base station 303. Base station 301 is also in communication with Internet 330 or a similar IP-based network (not shown).

Base station 302 provides wireless broadband access (via base station 301) to Internet 330 to a first plurality of subscriber stations within coverage area 320 of base station 302. The first plurality of subscriber stations includes subscriber station 311, which may be located in a small business (SB), subscriber station 312, which may be located in an enterprise (E), subscriber station 313, which may be located in a WiFi hotspot (HS), subscriber station 314, which may be located in a first residence (R), subscriber station 315, which may be located in a second residence (R), and subscriber station 316, which may be a mobile device (M), such as a cell phone, a wireless laptop, a wireless PDA, or the like.

Base station 303 provides wireless broadband access (via base station 301) to Internet 330 to a second plurality of subscriber stations within coverage area 325 of base station 303. The second plurality of subscriber stations includes subscriber station 315 and subscriber station 316. In an exemplary embodiment, base stations 301-303 may communicate with each other and with subscriber stations 311-316 using OFDM or OFDMA techniques.

Base station 301 may be in communication with either a greater number or a lesser number of base stations. Furthermore, while only six subscriber stations are depicted in FIG. 3, it is understood that wireless network 300 may provide wireless broadband access to additional subscriber stations. It is noted that subscriber station 315 and subscriber station 316 are located on the edges of both coverage area 320 and coverage area 325. Subscriber station 315 and subscriber station 316 each communicate with both base station 302 and base station 303 and may be said to be operating in handoff mode, as known to those of skill in the art.

Subscriber stations 311-316 may access voice, data, video, video conferencing, and/or other broadband services via Internet 330. In an exemplary embodiment, one or more of subscriber stations 311-316 may be associated with an access point (AP) of a WiFi WLAN. Subscriber station 316 may be any of a number of mobile devices, including a wireless-enabled laptop computer, personal data assistant, notebook, handheld device, or other wireless-enabled device. Subscriber stations 314 and 315 may be, for example, a wireless-enabled personal computer (PC), a laptop computer, a gateway, or another device.

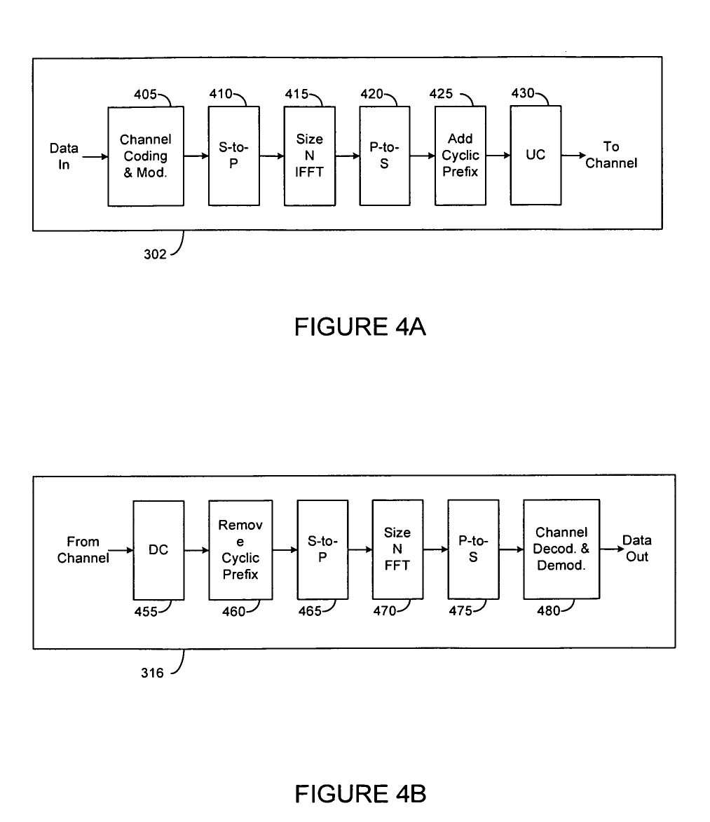

FIG. 4A is a high-level diagram of an orthogonal frequency division multiple access (OFDMA) transmit path. FIG. 4B is a high-level diagram of an orthogonal frequency division multiple access (OFDMA) receive path. In FIGS. 4A and 4B, the OFDMA transmit path is implemented in base station (BS) 302 and the OFDMA receive path is implemented in subscriber station (SS) 316 for the purposes of illustration and explanation only. However, it will be understood by those skilled in the art that the OFDMA receive path may also be implemented in BS 302 and the OFDMA transmit path may be implemented in SS 316.

The transmit path in BS 302 comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, up-converter (UC) 430. The receive path in SS 316 comprises down-converter (DC) 455, remove cyclic prefix block 460, serial-to-parallel (S-to-P) block 465, Size N Fast Fourier Transform (FFT) block 470, parallel-to-serial (P-to-S) block 475, channel decoding and demodulation block 480.

At least some of the components in FIGS. 4A and 4B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 302, channel coding and modulation block 405 receives a set of information bits, applies coding (e.g., Turbo coding) and modulates (e.g., QPSK, QAM) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 302 and SS 316. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at SS 316 after passing through the wireless channel and reverse operations to those at BS 302 are performed. Down-converter 455 down-converts the received signal to baseband frequency and remove cyclic prefix block 460 removes the cyclic prefix to produce the serial time-domain baseband signal. Serial-to-parallel block 465 converts the time-domain baseband signal to parallel time domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of base stations 301-303 may implement a transmit path that is analogous to transmitting in the downlink to subscriber stations 311-316 and may implement a receive path that is analogous to receiving in the uplink from subscriber stations 311-316. Similarly, each one of subscriber stations 311-316 may implement a transmit path corresponding to the architecture for transmitting in the uplink to base stations 301-303 and may implement a receive path corresponding to the architecture for receiving in the downlink from base stations 301-303.

The present disclosure describes an expedited handover procedure in which a target base station assigns a ranging slot dedicated to the mobile station using an expedited ranging information element (Expedited_Ranging_IE( )) message rather than a Fast_Ranging_IE( ) message.

The present disclosure also describes an expedited handover procedure in which a target base station assigns a ranging slot dedicated exclusively to two or more mobile stations allocated by the target base station, and each of the two or more mobile station is assigned a unique ranging code by the target base station using the Expedited_Ranging_IE( ) message rather than a Fast_Ranging_IE( ) message. In this case, there is no code collision because each mobile station uses a ranging code that is unique to that mobile station. The multiple access interference level of the dedicated ranging slot is controlled by the target base station because only those mobile stations allowed by the target base station can use the dedicated ranging slot.

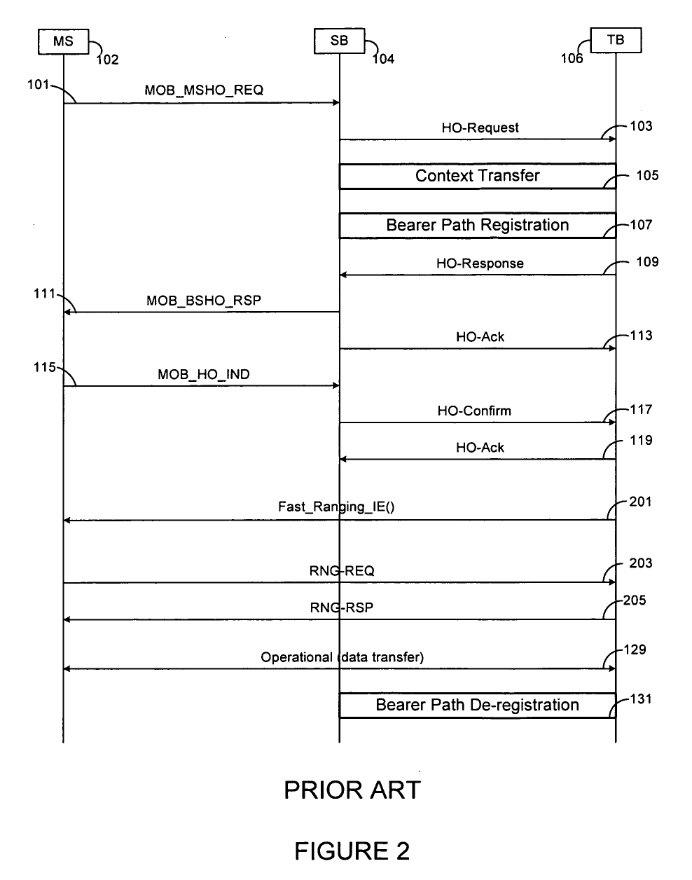

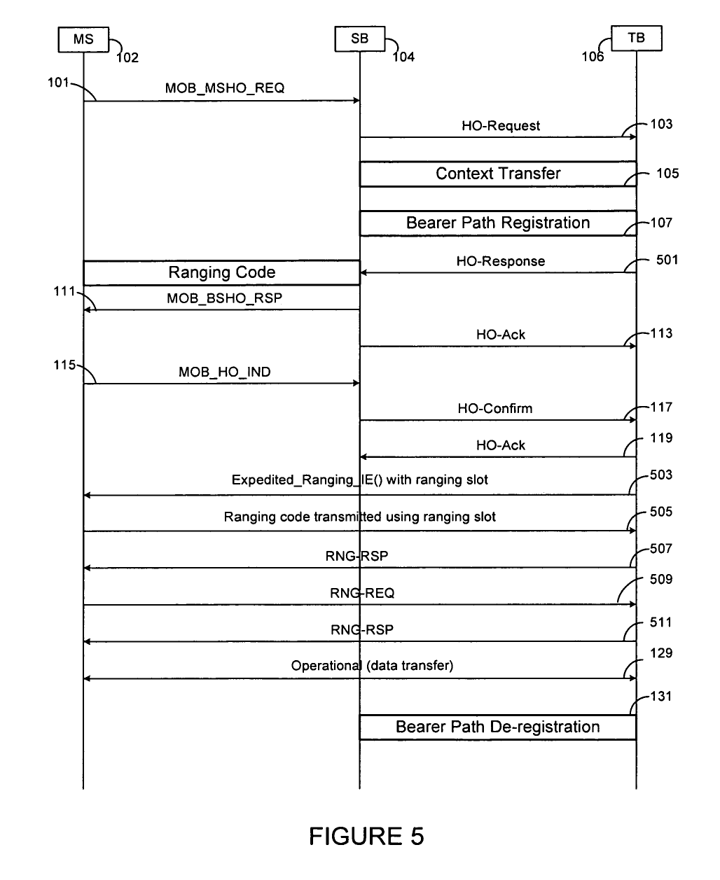

FIG. 5 is a flow diagram illustrating an expedited handover procedure according to an exemplary embodiment of the disclosure. As shown in FIG. 5, the expedited handover procedure of the present disclosure also employs steps 101 to 119 as shown in FIGS. 1 and 2. However, in this embodiment, the HO_Response from the target base station (step 501) contains a unique ranging code, which is transmitted to base station 102. In addition, rather than transmitting a Fast_Ranging_IE( ) message, target base station 106 transmits an Expedited_Ranging_IE( ) message to mobile station 102 (step 503). The Expedited_Ranging_IE( ) message assigns an exclusive ranging slot dedicated to those mobile stations allowed by the target base station to use the exclusive ranging slot. For the sake of simplicity, only one mobile station 102 is shown in the FIG. 5. However, one of ordinary skill in the art would recognize that the exclusive ranging slot may be dedicated to more than one mobile station. After mobile station 102 has received and decoded the Expedited_Ranging_IE( ) message, mobile station 102 performs ranging with target base station 106 and transmits the ranging code to target base station 106 using the exclusive ranging slot indicated in the Expedited_Ranging_IE( ) message (step 505). Before or during steps 503 and 505, target base station 106 obtains the MAC context for mobile station 102 in a message received from serving base station 104 or other central controller. In some embodiments, the message containing the MAC context may be transmitted to target base station 106 over a backhaul network.

Once target base station 106 receives the ranging code from mobile station 102, target base station 106 responds by sending a first RNG-RSP message to mobile station 102 (step 507). The first RNG-RSP message may contain valid ranging parameters, re-mapping of service flow ID/connection ID/security association ID (SFID/CID/SAID) or other necessary contexts. The entire handover process is completed when mobile station 102 receives the first RNG-RSP message from target base station 106 and applies all the changes provided in the first RNG-RSP message.

Upon receiving the first RNG-RSP message, mobile station 102 transmits a RNG-REQ message to target base station 106 (step 509), and target base station 106 responds by transmitting a second RNG-RSP message to mobile station 102 (step 511).

Accordingly, the expedited handover procedure of the present disclosure completes the handover procedure in one round of information exchange between mobile station 102 and target base station 106. Furthermore, the expedited handover procedure of the present disclosure does not require a mobile station to violate protocol by transmitting a RNG-REQ message in its first attempt at communicating with a target base station as done in optimized handover. The expedited handover procedure of the present disclosure performs a proper handover by having a mobile station transmit a ranging code to the target base station before the mobile station transmits a RNG-REQ message to the target base station.

In one embodiment of the present disclosure, the format for the Expedited_Ranging_IE( ) is shown in Table 1.

TABLE 1

| Syntax | Size | Notes |
|---|---|---|
| Expedited_Ranging_IE{ | | |
| Extended UIUC | 4 bits | Expedited_Ranging_IE( ) = 0x0B |
| HO ID | 8 bits | Assigned by target base |
| | | station |
| OFDMA symbol offset | 8 bits | |
| Subchannel offset | 7 bits | |
| No. OFDMA symbols | 7 bits | |
| No. subchannels | 7 bits | |
| Ranging method | 1 bit | 0 - Ranging over 2 symbols |
| | | 1 - Ranging over 4 symbols |
| Reserved | 6 bits | Shall be set to zero |
| } | | |

Accordingly, the present disclosure suggests the addition of one more item to Table 290a—“Extended UIUC Code Assignment for UIUC=15” of IEEE 802.16-2005. In one embodiment of the present disclosure, the modified Table 290a is shown in Table 2.

TABLE 2

| Extended | |
|---|---|
| UIUC | |
| (hexadecimal) | Usage |
| 00 | Power_control_IE |
| 01 | Reserved |
| 02 | AAS_UL_IE |
| 03 | CQICH_Alloc_IE |
| 04 | UL_Zone_IE |
| 05 | PHYMOD_UL_IE |
| 06 | Reserved |
| 07 | UL-MAP_Fast_Tracking_IE |
| 08 | UL_PUSC_Burst_Allocation_in_Other_Segment_IE |
| 09 | Fast_Ranging_IE |
| 0A | UL_Allocation_Start_IE |
| 0B | Expedited_Ranging_IE |
| 0C-0F | Reserved |

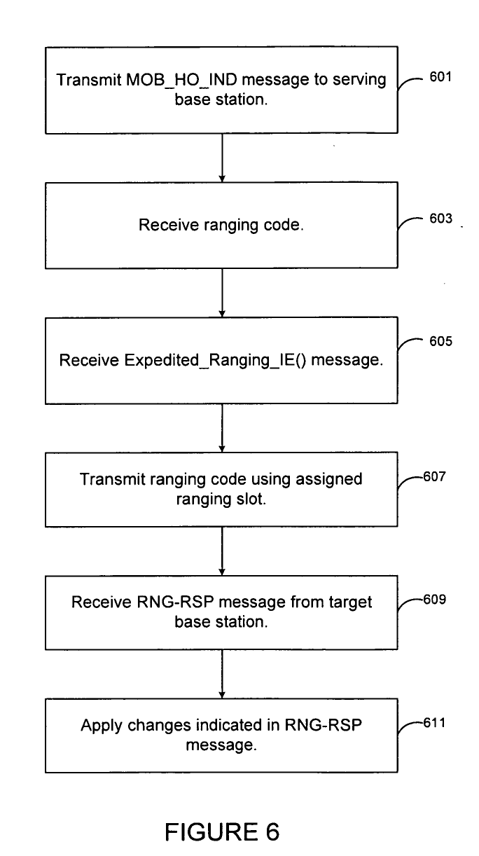

FIG. 6 is a flowchart illustrating a method for expedited handover according to an exemplary embodiment of the disclosure. In this embodiment, a mobile station transmits a MOB_HO_IND message to a serving base station indicating that the mobile station is requesting a handover to a target base station (step 601). After the mobile station transmits the MOB_HO_IND message, the mobile station receives a ranging code (step 603) and an Expedited_Ranging_IE( ) message (step 605) from the target base station. The Expedited_Ranging_IE( ) message contains a ranging slot dedicated to the mobile station. The mobile station decodes the Expedited_Ranging_IE( ) message and transmits the ranging code using the ranging slot indicated in the Expedited_Ranging_IE( ) message (step 607). If the ranging slot is dedicated exclusively to two or more mobile stations, the ranging code transmitted by the mobile station is a ranging code that is unique to the mobile station. The mobile station then receives a RNG-RSP message from the target base station (step 609). The RNG-RSP message may contain valid ranging parameters, re-mapping of SFID/CID/SAID or other necessary contexts. The mobile station then applies the changes indicated in the RNG-RSP message thereby completing the expedited handover procedure (step 611).

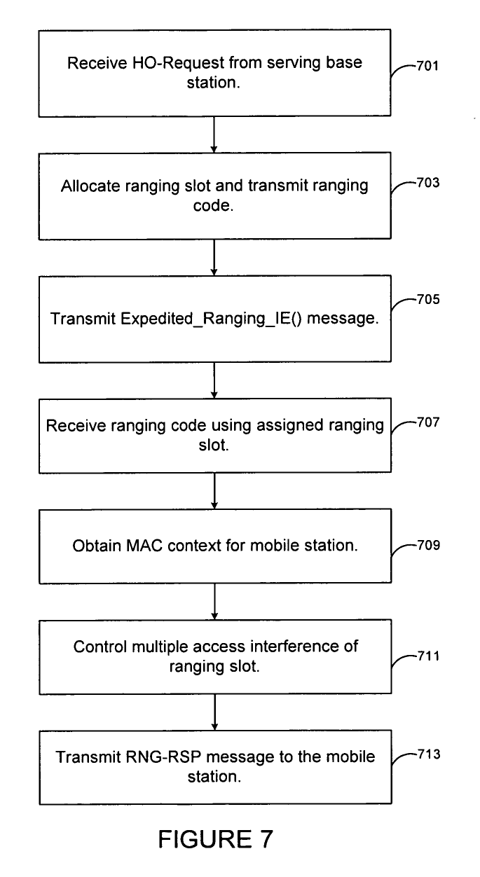

FIG. 7 is a flowchart illustrating a method for expedited handover according to another exemplary embodiment of the disclosure. In this embodiment, a target base station receives a HO-Request from a serving base station indicating that a mobile station served by the serving base station requests a handover to the target base station (step 701). The target base station then allocates a ranging slot dedicated to the mobile station and transmits a ranging code to the mobile station (step 703). If the ranging slot is an exclusive ranging slot dedicated to two or more mobile stations, the target base station transmits a ranging code that is unique to the mobile station.

The target base station then transmits an Expedited_Ranging_IE( ) message to the mobile station requesting handover (step 705). The Expedited_Ranging_IE( ) message contains a ranging slot dedicated to the mobile station. The target base station then receives the ranging code from the mobile station using the ranging slot indicated in the Expedited_Ranging_IE( ) message (step 707). Before or during step 707, the target base station obtains the MAC context for the mobile station in a message received from the serving base station or other central controller (step 709). In some embodiments, the message containing the MAC context for the mobile device may be transmitted to the target base station over a backhaul network. If the ranging slot is dedicated exclusively to two or more mobile stations, the ranging code received by the target base station is the ranging code that is unique to the mobile station, and the target base station controls the multiple access interference of the ranging slot using the unique ranging code (step 711). The target base station then transmits a RNG-RSP message to the mobile station (step 713). The RNG-RSP message may contain valid ranging parameters, re-mapping of SFID/CID/SAID or other necessary contexts. The entire handover process is completed when the mobile station receives the RNG-RSP message from the target base station and applies all the changes provided in the RNG-RSP message.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A wireless network comprising a plurality of base stations capable of communicating with a plurality of mobile stations, wherein:
a serving base station is operable to serve a mobile station; and
a target base station is operable to transmit to the mobile station a message identifying a ranging slot dedicated to the mobile station.

2. The wireless network of claim 1 wherein the target base station receives a ranging code from the mobile base station before the target base station receives a ranging request message from the mobile station

3. The wireless network of claim 1 wherein the target base station is operable to transmit a ranging response message to the mobile station, the ranging response message comprising one or more changes required by the target base station, and
wherein the target base station is operable to transfer data to the mobile station after the mobile station applies the one or more changes.

4. The wireless network of claim 3 wherein the one or more changes comprises a change in one from the group consisting of a ranging parameter, a service flow ID, a connection ID, and a security association ID of the mobile station.

5. The wireless network of claim 1 wherein the serving base station is operable to transmit to the target base station a message containing a medium access control (MAC) context for the mobile station.

6. The wireless network of claim 1 wherein the message identifying the ranging slot dedicated to the mobile station comprises an expedited ranging information element.

7. The wireless network of claim 1 wherein the ranging slot is an exclusive ranging slot dedicated to two or more mobile stations, and
wherein the target base station is operable to assign a unique ranging code that is unique to each of the two or more mobile stations and is operable to control a multiple access interference of the ranging slot using the unique ranging code.

8. A method of operating a target base station comprising:
allocating a ranging slot dedicated to a mobile station being served by a serving base station; and
receiving a ranging code from the mobile station using the ranging slot,
wherein the target base station receives the ranging code from the mobile base station before the target base station receives a ranging request message from the mobile station.

9. The method of claim 8 further comprising transmitting a ranging response message to the mobile station, the ranging response message comprising one or more changes required by the target base station, and
transferring data to the mobile station after the mobile station applies the one or more changes.

10. The method of claim 9 wherein the ranging response message comprises a change in one from the group consisting of a ranging parameter, a service flow ID, a connection ID, and a security association ID of the mobile station.

11. The method of claim 8 wherein the ranging slot is allocated to the mobile station in a message comprising an expedited ranging information element.

12. The method of claim 9 wherein the ranging slot is an exclusive ranging slot dedicated to two or more mobile stations.

13. The method of claim 12 further comprising:
assigning a ranging code that is unique to each of the two or more mobile stations, and
controlling a multiple access interference of the ranging slot using the unique ranging code.

14. A mobile station capable of communicating with a wireless network having a serving base station and a target base station, where the mobile station:
is operable to receive, from a target base station, a message identifying a ranging slot dedicated to the mobile station;
is operable to transmit a ranging code to the target base station using the ranging slot;
is operable to receive a ranging response message transmitted by the target base station, the ranging response message comprising one or more changes required by the target base station, and
is operable to apply the one or more changes in the ranging response message.

15. The mobile station of claim 14 wherein the mobile station transmits the ranging code to the target base station before transmitting a ranging request message to the target base station.

16. The mobile station of claim 14 wherein the ranging slot is allocated to the mobile station in a message comprising an expedited ranging information element.

17. The mobile station of claim 14 wherein the one or more changes comprises a change in one from the group consisting of a ranging parameter, a service flow ID, a connection ID, and a security association ID of the mobile station.

18. The mobile station of claim 14 wherein the ranging slot is an exclusive ranging slot dedicated to two or more mobile station.

19. The mobile station of claim 14 wherein the ranging code is a ranging code unique to the mobile station and is received from the target base station.
